(19) United States
(12) Patent Application Publication
(10) Pub. No.: US 2024/0254344 A1
(43) Pub. Date: Aug. 1, 2024

(54) HIGH TEMPERATURE-TOLERANT 3D PRINTED ARTICLES

(71) Applicant: IMPOSSIBLE OBJECTS, INC., Northbrook, IL (US)

(72) Inventors: Robert Swartz, Highland Park, IL (US); Michael Vasquez, Chicago, IL (US); Buckley Crist, Wilmette, IL (US); John Bayldon, Northbrook, IL (US); Eugene Gore, Des Plaines, IL (US)

(73) Assignee: IMPOSSIBLE OBJECTS, INC., Northbrook, IL (US)

(21) Appl. No.: 18/423,920

(22) Filed: Jan. 26, 2024

Related U.S. Application Data
(60) Provisional application No. 63/481,681, filed on Jan. 26, 2023.

(51) Int. Cl. C09D 7/40; B33Y 70/10; C09D 1/02; C09D 7/61; C09D 179/08; C08K 7/06; C08K 7/14

(52) U.S. Cl. CPC C09D 7/70; B33Y 70/10; C09D 1/02; C09D 7/61; C09D 179/08; C08K 7/06; C08K 7/14

(57) ABSTRACT

Processes for producing CBAM parts and/or components, including resulting articles, are disclosed. In one process, a fiber substrate binder possessing a flash point temperature greater than a predetermined processing temperature is used.

### REFERENCE TO RELATED APPLICATION

The present nonprovisional patent application claims priority to U.S. provisional patent application Ser. No. 63/481,681 filed Jan. 26, 2023, hereby incorporated by reference in its entirety.

### FIELD

The present subject matter relates to enhanced high temperature capabilities in articles made according to CBAM processes disclosed herein including related systems.

### BACKGROUND

U.S. Pat. No. 10,046,552 (incorporated herein by reference in its entirety) describes a system for the creation of 3D printed parts. This system operates according to principles that the assignee hereunder calls Composite-Based Additive Manufacturing (CBAM). In CBAM, a computer model divides a part to be printed into cross-sectional slices. Using printing technology (e.g., inkjet), a liquid is printed onto a porous sheet in a shape that corresponds to one of the cross sections of an object. The porous sheets are typically carbon fiber but may also comprise fiberglass or other suitable substrates. Also, the printing could occur on the end of a fed roll (or web), with cutting done at a downstream stage. The printed sheet gets flooded with a powder (typically, a thermoplastic powder) such that the powder adheres to printed regions and not to unprinted regions. Various means are deployed (e.g., vacuum, vibration, air knifing) to remove unadhered powder from a sheet. The sheet then moves to a stacking stage, where it is placed on top of a previous sheet (if present) that has gone through a similar process for the immediately adjacent object cross section. The stacker uses tapered registration pins to keep the sheets aligned, fitting into holes that were punched into such sheets at the upstream printing stage. The process is repeated for as many cross sections as will be needed to create a build block of multiple substrate sheets, each stacked on top of the other in a predetermined order necessary to represent all cross sections of the 3D object. The build block is subjected to subsequent processing in the form of heating and compression, so that powder on the printed areas melt and fuse. The resulting build block after heating and compression is then subjected to abrasion or chemical removal to remove substrate material, e.g., the friable carbon fiber regions that were never printed and flooded with powder. The melted/fused regions resist this abrasion, and thus emerge from the process in the intended shape of the final 3D printed part defined by the computer model. Advantageously, the use of carbon fiber and thermoplastic powder in this way leads to a resulting part that is extremely durable and well suited for high tolerances needed in industrial applications—hence, it is a so-called “composite-based” 3D printed part. The '552 patent describes various aspects of the system described hereinabove, and embodiments of subsystems carrying out each stage (i.e., material feeding, printing on a platen, powdering, removing powder, stacking, etc.).

As mentioned, CBAM includes heating and compression steps. When carbon fiber is used as a substrate, and a high temperature thermoplastic such as polyether ether ketone (known as PEEK) along with similar materials such as PAEK family of polymers is used as a resin, certain problems may become noticeable. For instance, a CBAM process may use substrates made by various commercially known non-woven processes, which for example use wet laid processes such as carbon fibers or fiberglass glued together with binder. The binders may include thermoplastic resin or starch, or other adhesive materials, which decompose and may combust at the melting point of PEEK, about 350 degrees Celsius (° C.).

Starch/resin decomposition in conventional non-woven substrates may be exothermic, causing heated binder to burn and produce fumes from breakdown of the binder. FIG. 1, a plot of temperature over time for a polyester binder without intervention (with two lines for two thermocouple placements within the same build-object), shows that temperature increases very rapidly after about 1 hour and 10 minutes from about 260° C. to about 755±15° C. at about 1 hour and 25 minutes. A “flash” or “burn” of the binder starts at the 260° C. transition point. This necessitates providing fume extraction systems sufficient not only to adequately ventilate associated production facilities (or use fume extractors) but also stop the burning from, for example, burning the carbon fiber.

One way to use starch/resin as a substrate binder while resolving the runaway thermal effect outlined above might be to insert thermocouples into various places within the build, continuously measure internal temperature of the build, and carefully control the heating and compression to reduce risk of ignition. This is difficult and time consuming since it requires conscious, skilled, and highly trained operators to monitor the operating process continuously, and to intervene appropriately when needed, to reduce the possibility of ignition. Since each part can be different, it is difficult to automate this step, as each different part requires a different sequence and protocol. And indeed, monitoring and adjusting becomes increasingly difficult when CBAM parts and components become larger in size and greater in height. Since 3D printing allows each part to be different, one cannot devise a simple protocol that will be appropriate for each part.

A different possible solution that retains the use of starch/resin substrate binder might be to control the temperature by wrapping the part, e.g., in aluminum foil to eliminate oxygen from entering the stack. However, this is cumbersome, and there will still be a minor amount of oxygen remaining in the stack, so that when the foil is removed, fumes would still need to be removed from the air. Even with a limited amount of oxygen, there is still some possibility of decomposition of binder in the veil even if does not burn. However there are advantages to this approach since there is a limited amount of burning that occurs which is controllable; this speeds up the heating of the part and thus speeds up processing.

A still further approach that retains the use of starch/resin binder is to heat the part in a chamber containing an inert gas such as nitrogen. However, when the chamber is not air-tight and the chamber and stack not evacuated before nitrogen is introduced, there will always be residual air in the stack, and the result will be the same as above. Moreover, if the chamber and stack were evacuated before the nitrogen had been introduced, the process would not be cost-effective, since nitrogen needed for operation of the process and its nitrogen-leaks would be quite expensive. As an alternative to the foregoing, the part may be heated in a complete vacuum. The use of an inert gas or a vacuum would serve the purpose of preventing the aforementioned (please see FIG. 1) exothermic reaction (a reaction that must use oxygen or another non-inert gas). Of course, even such measures may not completely prevent an ignition reaction, since a part, itself, may off-gas on heating, supplying the very gasses permitting a binder's runaway exothermic burn.

While yet another possible approach to controlling temperature might be to use an inorganic binder such as sodium silicate, such a binder is generally very difficult to cure.

### SUMMARY

Applicant, quite surprisingly, discovered an approach using a preselected polyimide binder. Polyimide (“PI”) is a polymer with imide groups and belongs to a class of high-performance polymers that have high heat resistant physical properties. For instance, the flash point of polyimide is such that it does not burn (create an exothermic reaction) at a processing temperature used to make PEEK parts. Without ignition from an exothermic reaction, temperature levels are effectively controlled.

### BRIEF DESCRIPTION OF THE FIGURES

FIG. 1 is a plot presenting a rapid rise in temperature (depicted on vertical axis) over time (depicted on horizontal axis) for an H&V polyester binder without intervention.

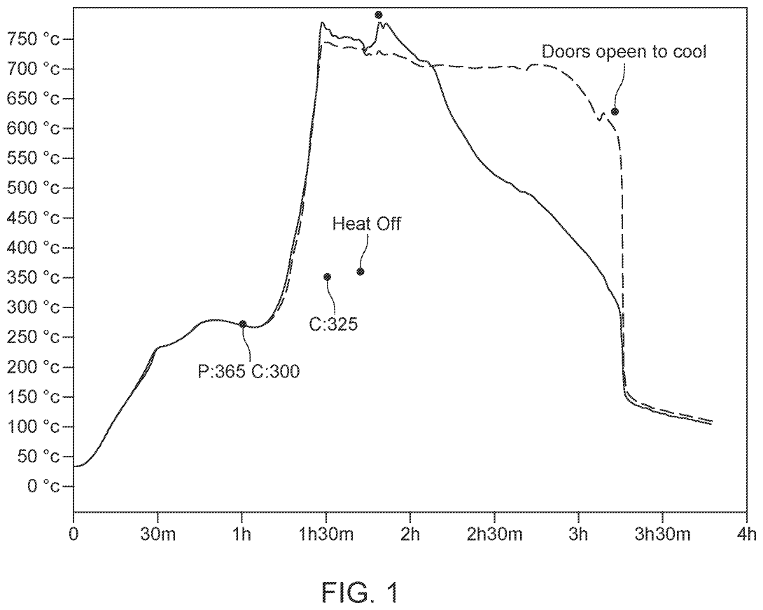

FIG. 2 is a plot representing temperature (depicted on vertical axis) versus time (depicted on horizontal axis) for a build block that makes use of TFP polyimide (from Technical Fibre Products, Burneside UK) as a binder.

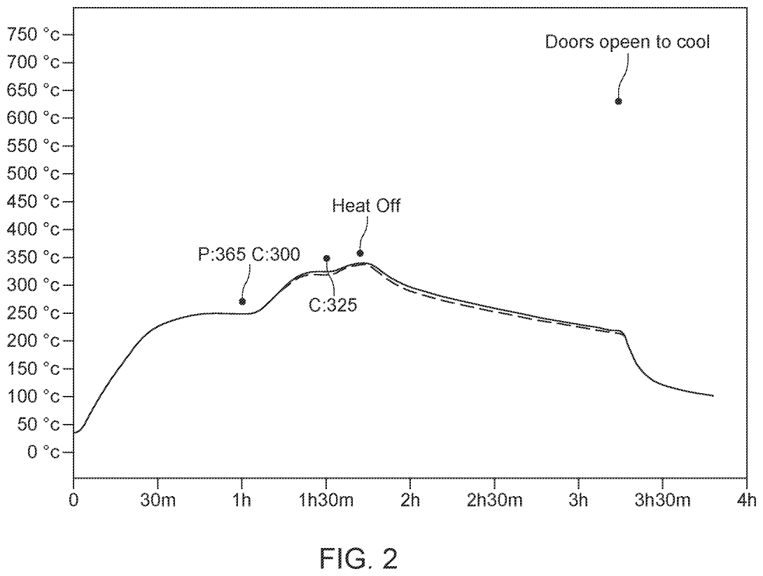

### DETAILED DESCRIPTION

The present subject matter is directed to high temperature processing of CBAM parts and components. The present applicant unexpectedly discovered an approach to solving a thermal degradation problem. A binder is used for the substrate sheets that (unlike the conventional adhesive, starch or resin) will not cause an exothermic reaction in the typical temperature ranges of build block heating. Preferably, a binder is selected such that exothermic reactions are absent up to temperatures of around 450° C. More preferably, exothermic reactions are absent up to temperatures of around 400° C. And most preferably, exothermic reactions are absent up to temperatures of around 340° C.

Briefly, one approach is to use a preselected polyimide binder in a predetermined processing step (although the binder selection is not necessarily limited to polyimide). Polyimide (“PI”), a polymer with imide groups, belongs to a class of high-performance polymers having high heat/flame/flash resistant physical properties. (The preferred polyimide binders include Hydrosize HP1632 and 1432 manufactured and commercially available by Michelman of Cincinnati, Ohio.) For instance, the flash point of polyimide is such that it does not burn at the processing temperature used to make PEEK parts.

Substrate sheets or webs may be made with polyimide (or other appropriate heat-resistant) binder as follows. Binder must be “cured” by a heating step during the process of making the non-woven substrate itself. Fibers used to make the substrate sheets may be either carbon fiber, fiberglass, a combination of carbon and fiberglass, or any other suitable nonwoven material that can lead to a high-quality 3D part. The process works approximately as follows, though any method of manufacture known to a person of skill in the art is appropriate. A water-based slurry of fiber and appropriate chemicals are mixed and then they are poured on a screen which consolidates the fiber into a mat. The mat is continuously taken off the screen as a web. There then is a waterfall of the liquid binder, in this case polyimide, or alternately application by foaming, to glue the fibers together. This is then heated to cure the binder, then there are calendaring steps and movement across heaters to remove the remaining water and dry along with compressing the web of material.

Using preselected polyimide materials instead of conventional starch/resin as a binder is surprisingly quite advantageous. Conventional exothermic binders greatly reduce processing time of a part under compression because they start an exothermic reaction, which very quickly makes everything very hot. Conversely, using a non-burning binder means that, without ignition to heat, temperature levels albeit more controlled, will max out lower, and thus will require more processing time for underlying polymer melt. Additional time is needed for the polymer to melt, leading to degradation of the polymer aspect of the part due to effects of extended holding at elevated temperature.

To reduce or eliminate degradation while using the advantageous burn resistant binder, two steps can be taken. A first step of a process of the present subject matter may be to heat the entire part, to a preselected temperature below the polymer melting point. And a second step, after the entire part has reached the preselected temperature, may be to further heat the entire part for raising its temperature to its melting point temperature.

An alternative approach, which is believed to also provide a viable solution to the above-described degradation problem, is initially to heat an entire part faster in the first step at, for example, a temperature of about 2-8° C. above the melting point of the part, and to use two or more thermocouples, suitably located, to obtain information as to when the entire part is approaching its melting point, and then reduce its temperature to perform the second step. It is believed that such an alternative approach would substantially reduce and/or eliminate heat-induced degradation of the CBAM parts and/or components.

Advantageously, articles made according to the foregoing steps will have excellent application in aerospace or other areas that require non-flammability of parts, since no starch/resin/adhesive of conventional CBAM processing is in the part. Hence the part's burn resistance is much enhanced for reasons described above for characterizing its burn resistance during manufacture. Final parts according to use of these improved binders disclosed herein will have a UL94 burn rating of V0, meaning that after two 10-second burning tests are performed on a specimen, any flame is extinguished within 10 seconds.

Another advantage of the final material is that it has EDS properties, that is, conductive or dissipative. This means that it does not hold static charge and can even be used in electronics manufacturing where such is required, for example, as solder pallets.

Another advantage of polyimide binder is that the parts are UL94V-0, meaning: That they will not burn or ignite, which is very important in, e.g., aerospace applications.

What has been illustrated and described in this patent application is subject matter directed to the high-temperature processing and manufacture of CBAM parts and components. While the present subject matter describing these articles of manufacture and process steps is disclosed and described in detail in relation to an assortment of embodiments (including current contemplations and beliefs), the present subject matter is not to be limited to these embodiments. On the contrary, many alternatives, changes, and/or modifications will become apparent to a person of ordinary skill in the art after this patent specification and its associated figures have been reviewed. Alternatives, changes, and/or modifications are, therefore, to be viewed as forming a part of the present subject matter insofar as they fall within the spirit and scope of the appended claims.

We claim:

1. A process for producing CBAM parts and/or components, wherein the process employs a predetermined processing temperature, and wherein the process comprises:
combining respective effective amounts of fibers fused together by a binder and a preselected thermoplastic material, for producing a CBAM stack; and
heating the CBAM stack at a preselected part-producing or component-producing temperature, for producing the CBAM parts and/or components,
wherein the binder has a flash point temperature greater than the processing temperature.

2. The process of claim 1, wherein the binder is a polyimide.

3. The process of claim 1, wherein the binder is a sodium silicate.

4. The process of claim 1, wherein the fiber is a carbon fiber.

5. The process of claim 1, wherein the fiber is a fiberglass material.

6. An article of manufacture made employing the process of claim 1.

7. A UL 94V-0 3D printed composite part made employing the process of claim 1.

8. The process of claim 1, wherein the respective effective amounts of fibers are glued together by the binder and the preselected thermoplastic material.

9. The process of claim 8, wherein the binder is a polyimide.

10. The process of claim 8, wherein the fiber is a carbon fiber.

11. The process of claim 8, wherein the fiber is a fiberglass material.

12. An article of manufacture made employing the process of claim 8.

13. A UL 94V-0 3D printed composite part made employing the process of claim 8.
